(19) United States
(12) Patent Application Publication
(10) Pub. No.: US 2012/0253822 A1
(43) Pub. Date: Oct. 4, 2012

(54) Systems and Methods for Managing Prompts for a Connected Vehicle

(76) Inventor: Thomas Barton Schalk, Plano, TX (US)

(21) Appl. No.: 13/524,645

(22) Filed: Jun. 15, 2012

Related U.S. Application Data
(63) Continuation-in-part of application No. 12/636,327, filed on Dec. 11, 2009.
(60) Provisional application No. 61/497,705, filed on Jun. 16, 2011.

(51) Int. Cl. G10L 11/00

(52) U.S. Cl. 704/270.1; 704/E11.001

(57) ABSTRACT

A method for providing audio prompts via a service-providing remote center includes receiving a list of requested data from an on-board navigation system of a vehicle, and, for each item in the list of requested data, determining whether an audio prompt is available and delivering an associated audio prompt from the service-providing remote center over a data channel. Also provided is a method for obtaining audio prompts using a minimal amount of text-to-speech ports including determining a plurality of known data items, generating audio prompts for the plurality of known data items with a single text-to-speech engine using batch mode processing, obtaining an associated audio prompt for each of the known data items, and storing each associated audio prompt in a recording database.

### CROSS REFERENCE TO RELATED APPLICATIONS

This application claims the priority, under 35 U.S.C. §119, of co-pending U.S. Provisional Application Ser. No. 61/497,705, filed on Jun. 16, 2011, the prior application is herewith incorporated by reference herein in its entirety.

This application is:
a continuation-in-part of U.S. Pat. No. 7,373,248 [Atty. Docket: ATX/Voice Delivered] (which claims the benefit of U.S. Provisional Application No. 60/608,850, filed on Sep. 10, 2004);
a continuation-in-part of U.S. Pat. No. 7,634,357 [Atty. Docket: ATX/Voice Delivered DIV1] (which is a divisional of U.S. Pat. No. 7,373,248); and
a continuation-in-part of U.S. patent application Ser. No. 12/636,327, filed Dec. 11, 2009 [Atty. Docket: ATX/Voice Delivered DIV2] (which is a divisional application of U.S. Pat. Nos. 7,373,248 and 7,634,357), the entire disclosures of which are hereby incorporated herein by reference in their entireties.

### FIELD OF THE INVENTION

The present invention relates in general to managing prompts in a connected vehicle, and in particular, to systems and methods for real-time generation and management of connected-vehicle audio prompts using an off-board solution.

### BACKGROUND OF THE INVENTION

Automotive navigation systems have been available for a number of years and are designed to guide vehicle operators to a specified destination. A major shortcoming of conventional navigation systems relates to the methods of entering target destinations. It is well known that driver distraction occurs when a vehicle operator interacts with a keypad or a touch screen while driving. In fact, first time users typically become frustrated with the human factors and associated learning necessary to enter target destinations manually. Furthermore, existing systems allow users to enter destination while driving, which has been shown to cause driver distraction. Entering an address or point of interest (POI) by using manual methods typically requires time and concentration on the vehicle operator's part and, in particular, one cannot watch the road or drive safely. There exists litigation that relates to driver distraction and the use of navigation systems while driving.

Another shortcoming of conventional navigation systems relates to the manufacturer or provider of the navigation system and is not typically understood by consumers. The shortcoming involves the cost associated with obtaining information from the location and map providers. Most manufacturers of navigation systems do not create the text-to-speech pronunciation libraries that are used by the navigation systems. Instead, they purchase licenses to use the libraries and are charged for each request. Another option for the manufacturer is to purchase a license to the entire content within the libraries, the cost of which is significant. It would be beneficial to provide a system that minimizes the cost associated with use of text-to-speech pronunciation libraries as well as text-to-speech engines.

For most in-vehicle navigation systems, there are sequential steps that occur during usage. The process begins with user interaction where the navigation system first determines the starting location, usually from GPS information. The target destination is typically entered as an address, a street intersection, or a point of interest. It would be a substantial advancement to the art if a menu-driven, automatic voice recognition system located at a remote data center is provided that recognizes spoken target destinations while simultaneously utilizing GPS information transmitted from the vehicle over a wireless link to the remote data center. It would also be a significant advancement to provide a voice user interface that is designed to minimize vehicle operator interaction time and/or data center operator interaction time. Finally, it would be a significant advancement if target destinations could be determined with high reliability and efficiency by utilizing the combination of GPS information, voice automation technology, operator assistance, and user assistance for confirming that the specified destination is correct while, at the same time, minimizes the cost of the text-to-speech licenses incurred by the manufacturer, which cost is passed onto the consumer in higher purchase prices. When necessary, an operator would be involved in determining the target destination that has been spoken, and the vehicle operator (the user) would confirm that the spoken destination is correct before the data center operator becomes involved. An automatic speech recognizer, high-quality text-to-speech, and GPS information each play a role in the overall process of determining a target destination.

### SUMMARY OF THE INVENTION

Accordingly, the present invention is directed to a system and a method of delivering, or downloading, navigation information from a remote data center database over a wireless link to a vehicle. The information delivered is in response to voice-recognized target destinations spoken by the operator of the vehicle. The voice recognition system is located at the remote data center. The information delivered, or downloaded, is, for example, the target destination POI, street intersection, or address. The destination is determined through a voice user interface whereby four components are involved in the automation process, including: voice technology, vehicle GPS information, the data center operator, and the vehicle operator. The information delivered, or downloaded, could also include the route information for the target destination POI, or address, determined through the voice user interface. The route information is also provided directly from the data center and not from or through third-party text-to-speech libraries.

The inventive systems and methods provide a menu-driven, automatic voice recognition system located at a remote data center that recognizes spoken target destinations while simultaneously utilizing GPS information transmitted from the vehicle over a wireless link to the remote data center. The inventive systems and methods further provide a voice user interface that is designed to minimize vehicle operator interaction time and/or data center operator interaction time. Finally, The inventive systems and methods determines target destinations with high reliability and efficiency by utilizing the combination of GPS information, voice automation technology, operator assistance, and user assistance for confirming that the specified destination is correct while, at the same time, minimizes the cost of the text-to-speech licenses incurred by the manufacturer, which cost is passed onto the consumer in higher purchase prices. When necessary, an operator is involved in determining the target destination that has been spoken, and the vehicle operator (the user) confirms that the spoken destination is correct before the data center operator becomes involved. An automatic speech recognizer, high-quality text-to-speech, and GPS information each play a role in the overall process of determining a target destination.

The primary advantages of the remote data center are flexibility and cost-effectiveness. Accurate, up-to-date data can be accessed and the amount of data can be very large because of memory technology. Because the automation platform is off-board, the application can easily be modified without changing any in-vehicle hardware or software. Such flexibility allows for user personalization and application bundling, in which a number of different applications are accessible through a voice main menu. In terms of cost, server-based voice recognition resources can be shared across a large spectrum of different vehicles. For example, forty-eight channels of server-based voice recognition can accommodate over 1,000 vehicles simultaneously.

The voice technology requirements for the invention include highly intelligible text-to-speech, speech recognition, n-best search results and associated recognition confidence levels. The term “n-best search results” refers to a common speech recognition output format that rank-orders the recognition hypotheses based on probability. The text-to-speech is used to represent what was recognized automatically and can be distinguishable from the vehicle operator's voice. A pronunciation database, also referred to as a phonetic database, is necessary for correct intelligible pronunciations of POIs, cities, states, and street names. For cases in which a recognition result does not have a high confidence score, a recording of what was spoken is played back to the vehicle operator for confirmation that the speech representation, or audio wave file, is correct and recognizable by a human, ultimately the data center operator. For example, if a vehicle operator says a city and state, a street name, and a street number, then the application repeats what was spoken in one of three ways: in a pure computer voice (text-to-speech), a combination of a computer voice and the vehicle operator's voice, or only in the vehicle operator's voice. In the latter case, the data center operator would listen to the speech and determine the address by listening and observing the n-best lists associated with each part of the address. In the former case, the data center operator would not be involved or needed; the process would be full automation. In the hybrid case, the data center operator would listen to part of what was spoken and determine the address by listening and observing the n-best lists associated with the part of the address not automatically recognized. It would be typical for the operator to listen and simply click on the n-best selection that matches the address component in question. Typing the address component would only be required if the n-best list does not contain the correct address component. When involved, the data center operator may choose to listen to any component of the address.

A similar strategy is used for determining a spoken POI. For POI entry, the voice user interface can be designed to capture a POI category (e.g., restaurant or ATM) and determine whether the nearest location is desired. If so, the spoken destination entry task is completed after confirmation with a “yes” response. If the nearest location is not desired, a “no” response is spoken and the vehicle operator is prompted to say the name of the POI. Similarly, if the category is not recognized, it is recorded and passed on to the data center operator in addition to the POI name, also recorded if not recognized, subsequent to vehicle operator confirmation that the recordings are correct. For POI determination, GPS may be used to constrain the active POI grammar based on a specified radius relative to vehicle location.

If a vehicle operator says a POI category and a POI name, then the application repeats what was spoken in one of three ways:
in a pure computer voice (text-to-speech);
a combination of a computer voice and the vehicle operator's voice; or
in the vehicle operator's voice only.
   In the latter case, the data center operator listens to all of what was spoken and determines the POI by listening and observing the n-best lists associated with the POI category and name. In the former case, the operator is not involved or needed as the process is fully automated. In the hybrid case, the data center operator listens to part of what was spoken and determines the POI through listening and observing the n-best list associated with either the POI category or name. It would be typical for the operator to listen and simply click on the n-best selection that matches the POI component in question. Typing the POI component would be required only if the n-best list does not contain the correct POI component. When involved, the data center operator may choose to listen to any component of the POI.

The invention described is intended to be integrated with a human machine interface (HMI) system. The HMI system may be an on-board system, e.g., on board a vehicle. In one embodiment, the on-board HMI system is an on-board navigation system capable of real-time GPS processing for route delivery. The navigation system is a hybrid solution in the optimized case because routes cannot be delivered as effectively in real-time from a remote data center. When turn-by turn directions are delivered directly from the remote data center, the GPS information specifying vehicle location can lose synchronization with actual vehicle position due to latencies in wireless communication between the vehicle and the remote data center. For example, a system-generated prompt (e.g., instruction to turn) may be experienced too late by the vehicle operator resulting in a route deviation. In summary, the ideal implementation utilizes on-board technology including real-time GPS information to deliver turn-by-turn directions by voice within the vehicle environment.

With the foregoing and other objects in view, there is provided, in accordance with the invention, a method of providing navigational information including the steps of processing destination information spoken by a user of a mobile processing system, transmitting the processed voice information via a wireless link to a remote data center, analyzing the processed voice information with a voice recognition system at the remote data center to recognize components of the destination information spoken by the mobile system user, generating at the remote data center a list of hypothetical recognized components of the destination information listed by confidence levels as calculated for each component of the destination information analyzed by the voice recognition system, displaying the list of hypothetical recognized components and confidence levels at the remote data center for selective checking by a human data center operator, selecting a set of hypothetical components based on the confidence levels in the list, confirming the accuracy of the selected set of hypothetical recognized components of the destination information via interactive voice exchanges between the mobile system user and the remote data center, determining a destination from confirmed components of the destination information, generating route information to the destination at the remote data center, and transmitting the route information to the mobile processing system from the remote data center via the wireless link.

In accordance with another mode of the invention, the accuracy confirming step includes transmitting a computer-generated representation of at least one hypothetical recognized component of the destination information to the mobile system user via the wireless link and prompting the mobile system user via the wireless link to aurally confirm the accuracy of the component of the destination information.

In accordance with a further mode of the invention, the accuracy confirming step includes transmitting at least one recorded hypothetical recognized component of the destination information spoken by the mobile system user to the mobile system user via the wireless link and prompting the mobile system user via the wireless link to aurally confirm the accuracy of the hypothetical recognized component of the voice destination information.

In accordance with an added mode of the invention, the accuracy confirming step includes determining if a confidence level of hypothetical recognized component is above a selected threshold and computer generating a representation of the hypothetical recognized component for transmission to the mobile system user when the confidence level is above the selected threshold.

In accordance with an additional mode of the invention, there is provided the step of determining the destination from the confirmed components comprises providing human data center operator assistance using the developed list of hypothetical recognized components and confidence levels to recognize the desired destination.

In accordance with yet another mode of the invention, the accuracy confirming step includes transmitting aural representations of hypothetical recognized components of the destination information to the mobile system user, the hypothetical recognized components of the destination information selected from the group consisting of aural representations of the destination address number, street name, city, state, and point of interest.

In accordance with yet a further mode of the invention, the data center operator assistance providing step includes playing back recorded representations of the destination information spoken by the mobile system user to the data center operator for analysis by the data center operator and receiving information from the data center operator identifying the destination.

In accordance with yet an added mode of the invention, the step of receiving information from the data center operator includes entering a choice from the displayed list of hypothetical components from the data center operator.

In accordance with yet an additional mode of the invention, the route information generating step includes generating route information from global positioning system information received by the data center from the mobile processing system.

With the objects of the invention in view, there is also provided a system for providing navigational information including a mobile system for processing and transmitting via a wireless link spoken requests from a mobile system user for navigational information to a selected destination and a data center for processing the spoken requests for navigational information received via the wireless link. The data center is operable to perform automated voice recognition processing on the spoken requests for navigational information to recognize destination components of the spoken requests, to confirm the recognized destination components through interactive speech exchanges with the mobile system user via the wireless link and the mobile system, to selectively allow human data center operator intervention to assist in identifying the selected recognized destination components having a recognition confidence below a selected threshold value, and to download navigational information to the desired destination for transmission to the mobile system derived from the confirmed destination components.

In accordance with again another feature of the invention, the data center is further operable to download the navigational information in response to position information received from the mobile system via the wireless link.

In accordance with again a further feature of the invention, the data center is further operable to generate a list of possible destination components corresponding to the spoken requests, to assign a confidence score for each of the possible destination components on the list, to determine if a possible destination component with a highest confidence score has a confidence score above a threshold, and to computer-generate an aural representation of the destination for transmission to the mobile system for confirmation by the mobile system user if the confidence score is above the threshold.

In accordance with again an added feature of the invention, the data center is further operable to determine that at least one destination component of the spoken request has a recognition confidence value below a threshold and to playback a recording in the voice of the mobile system user of at least the component with the recognition confidence value below the threshold to the mobile system user via the mobile system for confirmation.

In accordance with again an additional feature of the invention, the data center further includes a data center operator facility for playing-back the destination components for assisting in identifying the desired destination.

In accordance with still another feature of the invention, a selected spoken request includes a spoken request for point of interest information.

In accordance with still a further feature of the invention, the point of interest information includes information selected from names and categories.

In accordance with still an added feature of the invention, the destination components of a selected spoken request includes location information selected from the group consisting of information identifying state, city, street name, and address number.

In accordance with still an additional feature of the invention, the data center is further operable to record the spoken requests as normalized audio wave fields for subsequent playback.

In accordance with another feature of the invention, the data center is further operable to present a list of possible destinations listed by confidence scores to the data center operator for selection as the desired destination.

In accordance with still an additional mode of the invention, the data center is further operable to allow the data center operator to vary the order of the possible destinations in the list.

With the objects of the invention in view, there is also provided a method for providing audio prompts via a service-providing remote center, which comprises receiving a list of requested data from an on-board navigation system of a vehicle and, for each item in the list of requested data, determining whether an audio prompt is available and delivering an associated audio prompt from the service-providing remote center over a data channel.

In accordance with another mode of the invention, the audio prompt for the item is obtained when the audio prompt is determined to be unavailable.

In accordance with a further mode of the invention, the obtaining step is carried out by having the service-providing remote center obtain the item from the Internet cloud.

In accordance with an added mode of the invention, the item is generated with the service-providing remote center.

In accordance with an additional mode of the invention, the delivering step is carried out by sending the associated audio prompt to the vehicle over the data channel from the service-providing remote center.

In accordance with yet another mode of the invention, the obtained audio prompt is stored in a recording database of the service-providing remote center. In accordance with yet a further mode of the invention, the associated audio prompt is selected from a recording database of the service-providing remote center when the audio prompt is determined to be available.

In accordance with yet an added mode of the invention, the delivering step is carried out by sending the associated audio prompt from the service-providing remote center to the vehicle over the data channel.

In accordance with yet an additional mode of the invention, a richest available format of the audio prompt is selected and the audio prompt is sent in the richest available format. The richest available format comprises human voice, text-to-speech, and/or pre-recorded voice data.

With the objects of the invention in view, there is also provided a method for obtaining audio prompts using a minimal amount of text-to-speech ports comprises determining a plurality of known data items, generating audio prompts for the plurality of known data items with a single text-to-speech engine using batch mode processing, obtaining an associated audio prompt for each of the known data items, and storing each associated audio prompt in a recording database.

In accordance with again another mode of the invention, one or more of the associated audio prompts is selected from the recording database at a service-providing remote center in response to receiving a request from an on-board navigation system of a vehicle and the one or more associated audio prompts is sent from the service-providing remote center to the vehicle over a data channel.

In accordance with again a further mode of the invention, the known data items comprises at least one of cities, states, street names, and points-of-interest.

In accordance with again an added mode of the invention, the generating, obtaining and storing steps are carried out at a service-providing remote center and a pronunciation of each associated audio prompt is optimized at the service-providing remote center using a pronunciation database.

In accordance with again an additional mode of the invention, one or more of the optimized associated audio prompts is selected from the recording database in response to a request from an on-board navigation system of a vehicle and the one or more optimized associated audio prompts is sent from the service-providing remote center to the vehicle over a data channel.

In accordance with still another mode of the invention, the optimizing step is carried out by having the audio prompts sound like an on-board voice persona of a vehicle.

With the objects of the invention in view, there is also provided a method for transferring sound properties into another target comprises selecting a plurality of audio prompts saved in a recording database of a service-providing remote center, optimizing a pronunciation of the plurality of audio prompts using a pronunciation database of the service-providing remote center, and saving the optimized pronunciation of the plurality of audio prompts in the recording database.

With the objects of the invention in view, there is also provided a service-providing remote center comprises a data center operable to process a list of requested data received from an on-board navigation system of a vehicle, a database containing audio prompts, a communications data channel, and a processor operably connected to the data center and the database and being operable to check the database to determine whether an audio prompt is available for each item in the list of requested data and to deliver each associated audio prompt to the vehicle over the communications data channel.

Although the invention is illustrated and described herein as embodied in systems and methods for off-board voice-automated vehicle navigation, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Additional advantages and other features characteristic of the present invention will be set forth in the detailed description that follows and may be apparent from the detailed description or may be learned by practice of exemplary embodiments of the invention. Still other advantages of the invention may be realized by any of the instrumentalities, methods, or combinations particularly pointed out in the claims.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

### BRIEF DESCRIPTION OF DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages all in accordance with the present invention. Advantages of embodiments of the present invention will be apparent from the following detailed description of the exemplary embodiments thereof, which description should be considered in conjunction with the accompanying drawings in which:

FIG. 1A is a block diagram of an exemplary off-board voice-automated vehicle navigation system embodying the principles of the present invention;

FIG. 1B is a flow chart illustrating representative voice-automated vehicle navigation operations implemented in the system shown in FIG. 1A;

FIG. 2 is a conceptual diagram of a representative data center display suitable for implementing data center operator assistance in target destination recognition based on point of interest (POI) information;

FIG. 3 is a conceptual diagram of a representative data center display suitable for implementing data center operator assistance in target destination recognition based on city and state information;

FIG. 4 is a conceptual diagram of a representative data center displays suitable for implementing data center operator assistance in target destination recognition based on city, state, and street name information;

FIG. 5 is a conceptual diagram of a representative data center displays suitable for implementing data center operator assistance in target destination recognition based on city, state, and street name information;

FIG. 6 is a flow diagram of an exemplary process for managing prompt data associated with a remote service provider according to the present invention;

FIG. 7 is a conceptual process flow diagram of the process of FIG. 6 in an embodiment where a remote data center assists a vehicle with turn-by-turn navigation;

FIG. 8 is a conceptual process flow diagram of the process of FIG. 6 in an embodiment where a remote data center assists a vehicle with management of music information;

FIG. 9 is a conceptual process flow diagram of the process of FIG. 6 in an embodiment where a remote data center assists a vehicle with management of point-of-interest information

FIG. 10 is a flow diagram of a method for obtaining audio prompts using a minimal amount of text-to-speech ports, according to one exemplary embodiment; and

FIG. 11 is a flow diagram of a method for transferring sound properties into another target, according to one exemplary embodiment.

### DETAILED DESCRIPTION OF THE INVENTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

Alternate embodiments may be devised without departing from the spirit or the scope of the invention. Additionally, well-known elements of exemplary embodiments of the invention will not be described in detail or will be omitted so as not to obscure the relevant details of the invention.

Before the present invention is disclosed and described, it is to be understood that the terminology used herein is for the purpose of describing particular embodiments only and is not intended to be limiting. The terms “a” or “an”, as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

Relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

The terms “program,” “software,” “software application,” and the like as used herein, are defined as a sequence of instructions designed for execution on a computer system. A “program,” “software,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

Herein various embodiments of the present invention are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

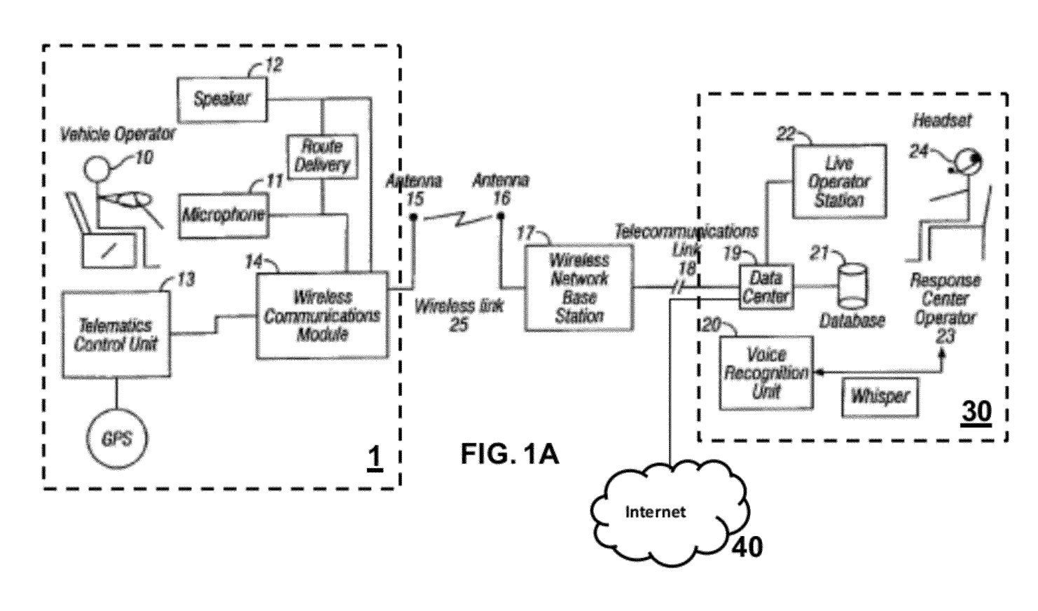

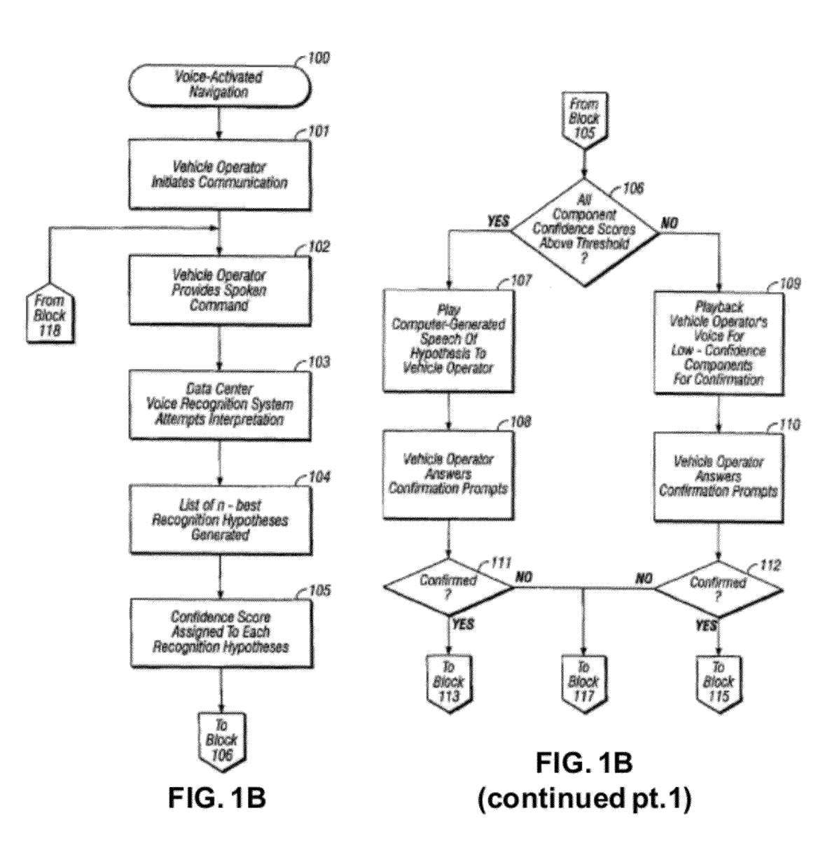

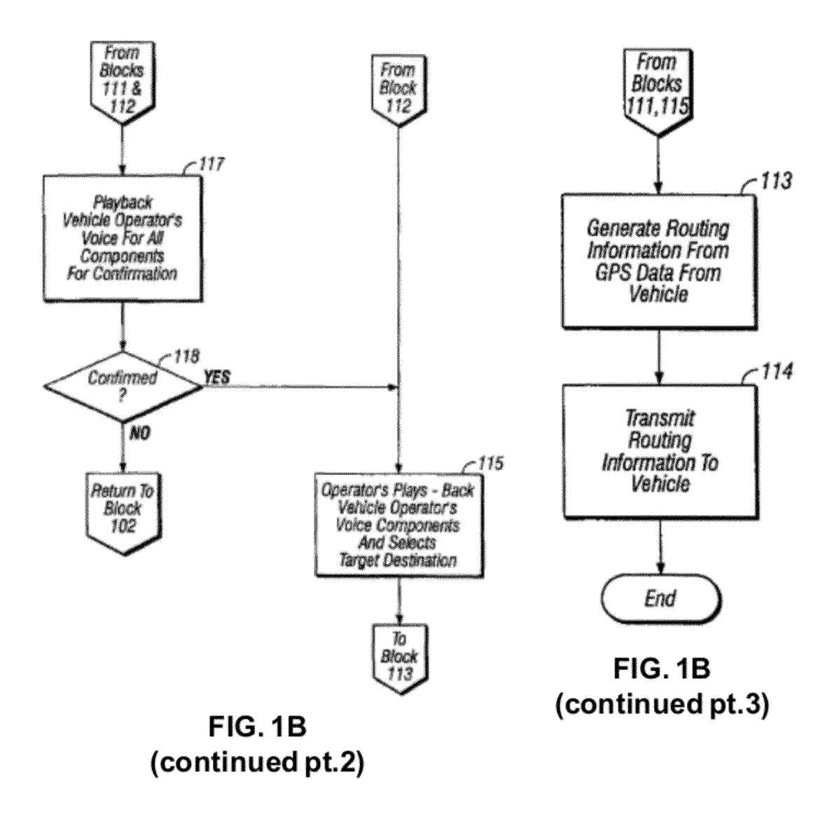

Described now are exemplary embodiments of the present invention. Referring now to the figures of the drawings in detail and first, particularly to FIG. 1A, there is shown a diagram of a first exemplary embodiment of an off-board voice-automated navigation system embodying the principles of the present invention. FIG. 1B is a flow chart of a procedure 100 illustrating representative operations of the inventive systems and processes, also embodying the principles of the present invention.

Referring to FIGS. 1A and 1B, when the vehicle operator 10 wishes to enter a target destination in order to receive route guidance, a wireless communications link is initiated to the remote data center 19 at block 101 of procedure 100. The process could be initiated in a number of ways, such as speaking a command in the vehicle 1 or by pressing a button. Communication is established and the vehicle operator 10 speaks commands into the hands-free microphone 11, located in proximity to the vehicle operator 10, at block 102.

The vehicle operator's spoken commands pass over the wireless link 25 via the vehicle mounted wireless communication module 14, the vehicle mounted wireless antenna 15, the wireless network's antenna 16, the wireless network base station 17, through one of many telecommunications networks 18, and into the data center 19. From the data center, the voice recognition unit 20 interprets the spoken command(s). The commands include information regarding an address, POI, or street intersection. For an address entry, the city and state may be spoken first.

The voice recognition unit 20 attempts, at block 103 of procedure 100 of FIG. 1B, to recognize the spoken input and, at block 104, creates an n-best list of the top hypotheses, where n typically does not exceed five (that is, the recognition unit 20 generates up to five text representations of possible city/state combinations, each with an associated probability of correct recognition). Each recognition hypothesis is assigned a confidence score (probability), at block 105, that is normalized to 1. If the top choice is assigned a confidence score above a specified threshold, at decision block 106, the spoken input is considered to be recognized, and computer-generated text-to-speech speech audio is played to the vehicle operator 10 (block 107) for confirmation (block 108). If confirmation is positive at block 111, then at blocks 113 and 114 routing information is generated automatically and transmitted to the on-board telematics control unit 13.

The speech audio is directed to the vehicle speaker(s) 12 in a hands-free environment. The vehicle operator 10 responds into the hands-free microphone 11 to each system prompt to specify an address, thereby saying a city, state, street name, and street number. The vehicle operator 10 listens to the vehicle speaker(s) 12 to hear the hypothesized address represented by speech audio that is 1) purely computer generated, 2) purely the speech of the vehicle's operator 12, or 3) a combination of the two types of speech audio.

The computer-generated voice, utilized at block 107 of procedure 100, only occurs for recognized utterances (top-choice recognition with high confidence). Destination components (city, state, street name and number, POI, etc.) are otherwise individually aurally identified in the vehicle operator's 12 own voice for confirmation when the confidence score falls below a threshold. In particular, if some, or even all, of the destination components spoken by the vehicle operator have confidence scores below the threshold at block 106, then at least those low confidence components are played-back to the vehicle owner in the vehicle operator's own voice at block 109, for confirmation at block 110. If the vehicle operator confirms the play-back of block 109, then at decision block 112 procedure 100 continues to block 115 for data center operator assistance for determination of the proper destination and generation of the appropriate navigational directions.

On the other hand, when the first attempted confirmation yields a negative result at either block 111 or block 112 of procedure 100, a second play-back is performed at block 117 and a second confirmation from the vehicle owner is attempted at block 118. For the second attempt at confirmation, all destination components are played-back to the vehicle operator. A positive confirmation at block 118 concludes the user experience for destination entry, after which the operator becomes involved at block 115, if needed. It should be emphasized that if the target destination is spoken and recorded correctly, it does not need to be spoken again by the vehicle operator 12; however, if the vehicle operator 12 still does not confirm the destination components from the second confirmation attempt, then procedure 100, for example, returns to a main menu and the vehicle operator is requested to repeat the desired destination at block 102.

It is important to emphasize that the vehicle operator 10 confirms that the stored audio wave file is accurate before the response center operator 23 becomes involved. A yes/no confirmation via the voice recognition unit 20 is required for all destinations before the data center operator 23 becomes involved, if needed at all. If the confirmation is negative, another choice on the n-best entry list is selected at decision block 106, for playback at block 109 and another attempt at confirmation is made at block 110.

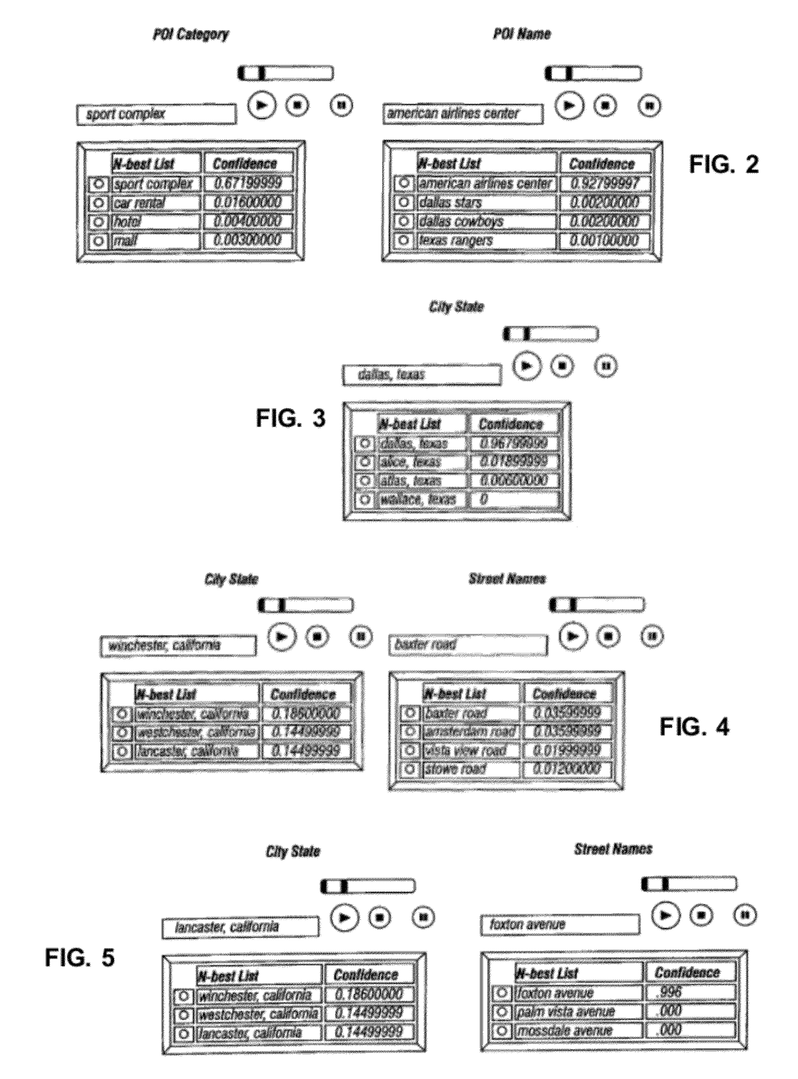

FIG. 2 represents a sample screen shot from the live operator station 22 that is designed to assist the response center operator 23, at block 115 of procedure 100, in determining a target destination. The example shown is for a specific POI, including the corresponding POI category. FIG. 2 illustrates two n-best lists side-by-side, one for the POI category (left) and one for the corresponding POI name (right). The confidence scores are listed next to each recognition hypothesis shown in the n-best lists, and serve to indicate the relative likelihood that the phrase that was spoken is what is listed. For the hypothesis “sport complex,” the confidence score shown is 0.67199999, which is significantly better than the confidence score for the next best choice, 0.01600000 (the hypothesized spoken phrase, “car rental”). The two boxes above the hypothesis lists contain text that matches the first choices from the n-best lists therebelow. The text contained within each of the two boxes can be modified by the response center operator 23 either by character-by-character entry from a keyboard or by selecting an n-best entry in the list, which can be performed using a mouse or other measures such as a keyboard. To the right of each of these two upper boxes are audio controls (play, stop, and pause buttons) that allow the stored audio wave files to be played and listened to by the response center operator 23.

The ability of the data center operator to play the audio wave file representations of the spoken destination components is important to the overall process. For the example under consideration, there are two destination components: the POI category and the POI name. If a phrase other than the top choice is selected from either n-best list, then the text in the corresponding upper box changes automatically. In the example shown, if a different POI category is chosen by the response center operator 23, then a different subsequent grammar can be activated; the n-best list for the POI changes and a new top choice is automatically entered into the upper box for the POI name. The confidence scores for the new n-best list will be quite different and would be expected to be significantly higher if the stored audio wave file matches a grammar entry well. For the example described here, the vehicle operator says a POI category. The category is recognized and the vehicle operator 10 is asked if the nearest “sport complex” is the desired destination. A positive response completes the destination entry on the user interface side because the GPS information for the vehicle position is all that is needed to determine the route at block 113 of procedure 100. The GPS is used as the starting point and the nearest POI is determined based on category screening and distance.

FIG. 3 represents part of sample screen shot from the live operator station 22 that is designed to assist the response center operator 23, at block 115, in determining a target destination component. The example shown is for a specific city and state and includes the n-best list generated by the voice recognition unit 20 for the city and state that was spoken by the vehicle operator 10. The confidence scores are listed next to each recognition hypothesis shown in the n-best list and serve to indicate the relative likelihood that the phrase that was spoken is what is listed. For the hypothesis “Dallas Tex.,” the confidence score shown is 0.96799999, which is significantly better than the confidence score for the next best choice, 0.01899999 (the hypothesized spoken phrase, “Alice, Tex.”).

Referring again to FIG. 3, the upper box contains text that matches the first choices from the n-best lists. The text contained within the box can be modified by the response center operator either by character-by-character entry from a keyboard or by selecting an n-best entry by using a mouse or other measures such as a keyboard. To the right of the upper box are audio controls that allow the stored audio wave files to be played and listened to by the response center operator 23. Again, the ability to play the audio wave file representations of the spoken destination components is important to the overall process. If a phrase other than the top choice is selected from the n-best list, then the text in the corresponding upper box changes automatically. The audio wave file represents speech provided by the vehicle operator 10 (in this case, a city and state).

FIG. 4 represents another screen shot from the live operator station 22 that is designed to assist the response center operator 23 in determining a target destination. The example shown is for a specific city, state, and street name. FIG. 4 illustrates two n-best lists side-by-side, one for the city and state and one for the street name. The confidence scores are listed next to each recognition hypothesis shown in the n-best lists and serve to indicate the relative likelihood that the phrase that was spoken is what is listed. For the hypothesis “Winchester, Calif.” the confidence score shown is 8600000, which is not significantly better than the confidence score for the next best choice, 0.14499999 (the hypothesized spoken phrase, “Westchester, Calif.”). Referring to FIG. 4, the two boxes above the n-best lists contain text that matches, respectively, the first choice from each of the two n-best lists therebelow. The text contained within the two upper boxes can be modified by the response center operator either by character-by-character entry from a keyboard or by selecting an n-best entry using a mouse or other measures such as a keyboard. To the right of each box are audio controls that allow the stored audio wave files to be played and listened to by the response center operator 23.

The ability to play the audio wave file representations of the spoken destination components is important to the overall process. For the example under consideration, there are two destination components: the city/state and the street name. If a hypothesis other than the top choice is selected from either n-best list, then the text in the corresponding upper box changes automatically. In the example shown, if a different city/state is chosen by the response center operator 23, then a different subsequent grammar is activated; the n-best list for the street name changes and a new top choice is automatically entered into the upper box for the street name. FIG. 5 illustrates the result that occurs when “Lancaster, Calif.” (the third entry in the list of FIG. 4) is chosen by the response center operator 23. The confidence scores for the new n-best list of street names are quite different and, according to the invention, the top choice street has a high confidence score, 0.996, which is close to being a perfect match. The response center operator's 23 task for the example described here is noted as follows:
1) listen to the city/state audio wave file;
2) select the correct city/state;
3) listen to the street name audio wave file to confirm that it is correct; and
4) listen to the street number audio wave file to confirm that it is correct (not illustrated) and make any typed corrections if needed before final submission for navigation-related processing.

The level of captured audio wave files can be normalized by applying digital automatic gain control to improve human intelligibility and user interface consistency during audio play back of destination components. The captured audio can serve to indicate the quality of the network conditions to the vehicle operator. The captured audio teaches the vehicle operator how to speak into the microphone to achieve optimal recognition.

It is noted that communication between the vehicle 1 and the service-providing remote center 30 is required for all instances where information is not available to the driver 10 within the vehicle 1. Such communication is time-consuming already, leading to driver impatience. When information is required from off-board sources, the delay-to-respond times increase. One process where information is needed from off-board sources is turn-by-turn navigation. Although the invention is not limited in any way to turn-by-turn navigation, this particular process illustrates the inventive system well and, therefore, will be used as merely a first example. Other examples illustrating the breadth of the inventive prompt management systems and methods, such as music and point-of-interest management, are possible and are described herein as well, although not in as much detail to avoid unnecessary repetition.

Most navigation systems do not always tell the vehicle operator 10 the street names in a turn-by-turn navigation for many reasons. First, for example, there are just too many street names to make it practical to store all of the text-to-speech audio files on-board. Second, new streets are created so often, that it is impractical to continually update the on-board text-to-speech audio files. As such, many turn-by-turn navigation solutions work independently of the associated on-board navigation display system. The on-board display system is able to take in the endpoints of a route, for example, based on a destination from a present location of the vehicle 1, and determine requested data, e.g., the list of streets making up the selected route to the desired destination. But, once the streets of the route are determined, the on-board display system needs data for pronouncing the names, either in real-time as the route is traversed or when the user asks the on-board display system to sound out the next street name, for example. Simply put, the vehicle 1 needs to have the prompts for the audio downloaded/placed into on-board navigation display system. Accordingly, when a vehicle 1 needs a street name, the service provider 30 obtains this information from an off-board navigation provider, such as NAVTEC® or TELE ATLAS®, for example. But, companies such as these charge license fees for each request for information. Where millions of vehicles and navigation systems exist and these request hundreds of street names per week, month, or year, the license cost to off-board navigation assistance companies, such as the service provider 30 becomes prohibitive—especially when the same street names are requested over and over again by vehicle operators 10.

Up to now, audio files were generated by running the text of the street name text strings through text-to-speech engines in real time to get the pronunciation rules (from a company such as NAVTEC® or Nuance®). In this way, two licensed components were used every time a street was provided to the millions of cars: (1) the text-to-speech engine and (2) the street information data. This meant that the service provider 30 was required to pay large license fees.

The present invention minimizes such costs as well as eliminates the extra delay associated with the data center 19 requesting such information from the off-board navigation provider 50, most typically over an interface through the Internet 40. To do this, the invention either generates all street names using one text-to-speech engine or obtains all (or most) street names once from the third party provider 50. This generates a usable evaluation copy of the name data as a so-called “recording database” at the service provider 30. Thereafter, these pre-recorded files are available to the provider 30 on demand and there no longer exists the need for licenses to the already loaded names. In this way, a street name request is never repeated.

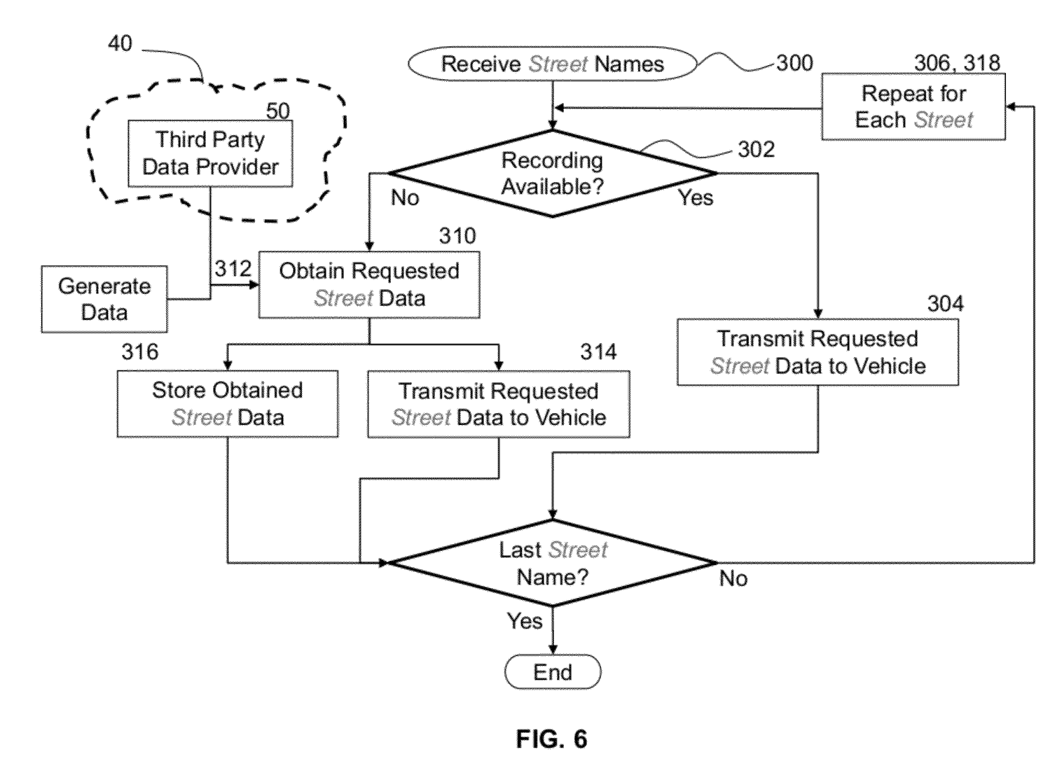

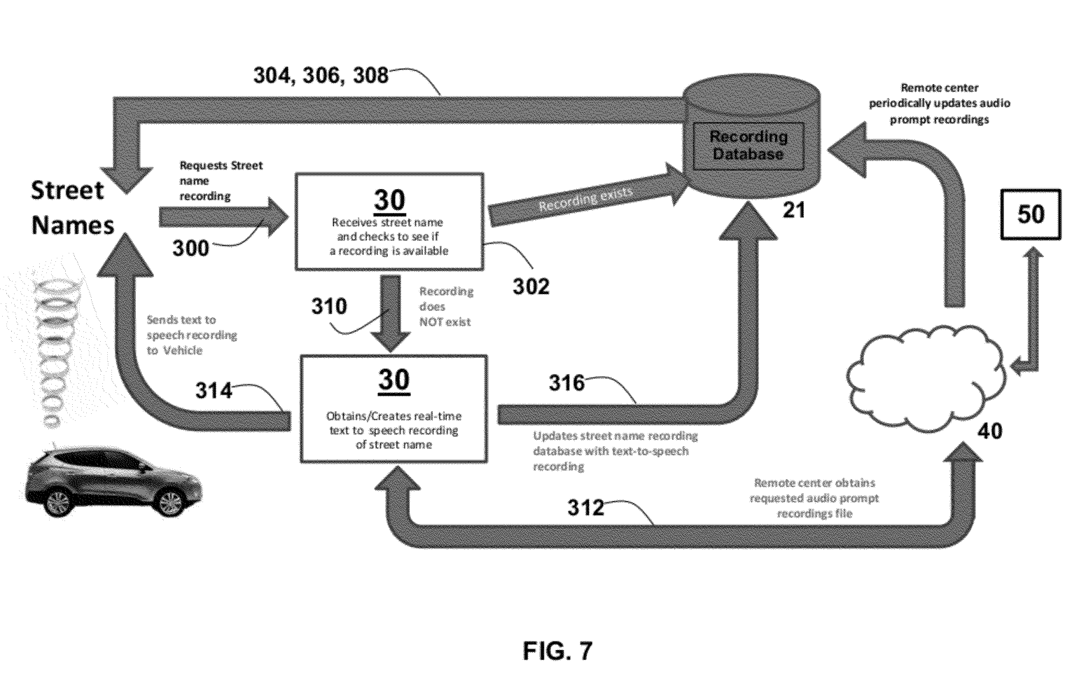

The invention is unique for a connected vehicle 1 and generalizes to any audio prompt that needs to be played from the vehicle speaker 12 or other vehicle hardware—i.e., it is not limited to just navigation processes. FIGS. 6 and 7 illustrate one exemplary context of the inventive prompt management processes and systems applied in the navigation setting. After the on-board HMI system, e.g. on-board navigation system, of the vehicle 1 has generated a list of requested data, e.g., the street names for a desired route, it sends those names to the data center 19 for processing. The start of the inventive method begins here and is shown in step 300 of FIG. 6 where the list of requested data is received. In step 302, the remote center 30 determines if the text-to-speech information is already present in the invention's recording database, which is a part of the database 21 of the data center 19. The invention uniquely creates this recording database by storing every previously requested text-to-speech information obtained from outside third parties 50. Because there is a cost associated with each requested text-to-speech information from providers of such information, the data center 19 need only pay once for each request—instead of paying multiple times for each request over the life of the database. The recording database can be initially populated with any number of data entries corresponding to the text-to-speech information needed for the particular application, which, here, is a navigation example requiring text-to-speech information related to street names for audio pronunciation to the vehicle operator 10.

If the recording, e.g., audio prompt, sought by the vehicle 1 exists in the recording database, then, in step 304, the data center 19 selects the corresponding street name recording in the richest available format and sends it to the vehicle 1, e.g., over a data channel established via telecommunications link 18 and wireless link 25, either in human voice or text-to-speech. This process is repeated, in step 306, for each of the street names requested until the last street name data is transmitted to the vehicle 1.

Alternatively, if the recording sought by the vehicle 1 does not exist in the recording database, then, in step 310, the data center 19 obtains the corresponding street name recording. Accordingly, the data center 19 communicates with the cloud 40 (e.g., to NAVTEQ®) to obtain that data in step 312. If desired, the data center 19 can be provided with the functionality of creating the requested data. Either way, once the data center 19 has the requested data, then, in step 314, the data is transmitted to the vehicle 1, e.g., over the data channel. Either at that time or after, the data center knows that the just-obtained data is not currently present in the recording database 21. As such, in step 316, the data center 19 stores the data just obtained within the recording database 21 so that it can be used in the future. This process is repeated, in step 318, for each of the street names until the last street name data is transmitted to the vehicle 1. It is noted that the word “street” in the process flow diagram of FIG. 6 is indicated with italics. This is because the process is not limited to obtaining only street information. Thus, this word can be substituted out for any other kind of data being requested and, therefore, “street” is only exemplary as a data type.

One significant advantage of the invention is that the recording database does not have to blindly follow and use whatever text-to-speech information provided by the text-to-speech information provider 50. Instead, for any number of entries in the recording database, the invention can substitute robotic text-to-voice pronunciation with pre-recorded, pleasant voice data. Further, it is apparent that the time to obtain data from the database 21 controlled by the service provider 30 is significantly faster than the time it takes the remote center 30 to ask third parties 50 for the desired data and receive that data.

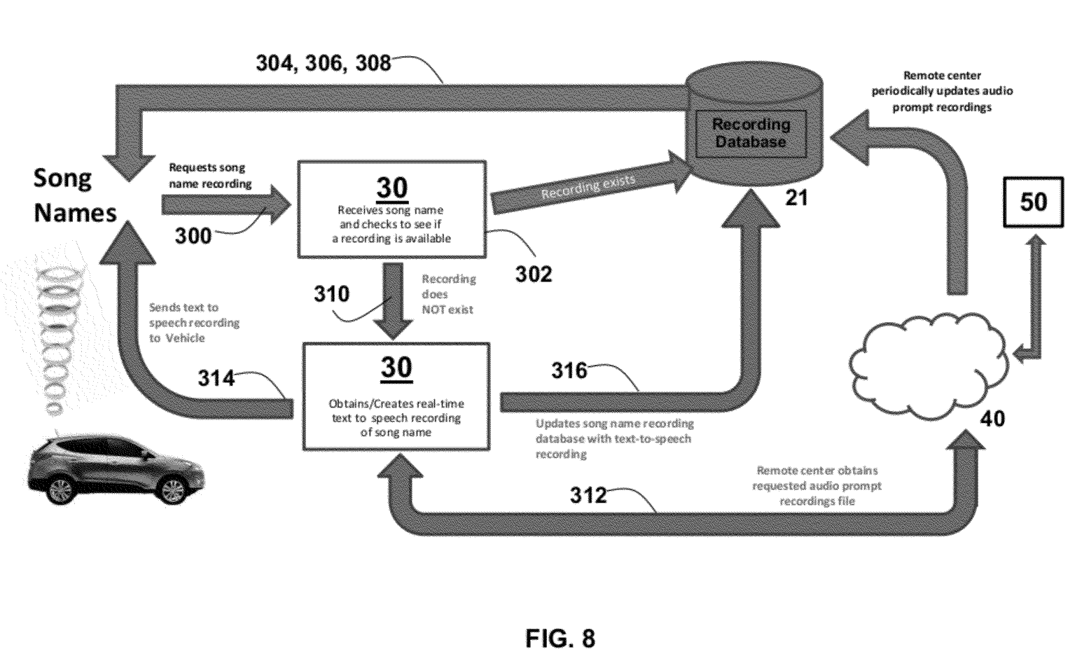

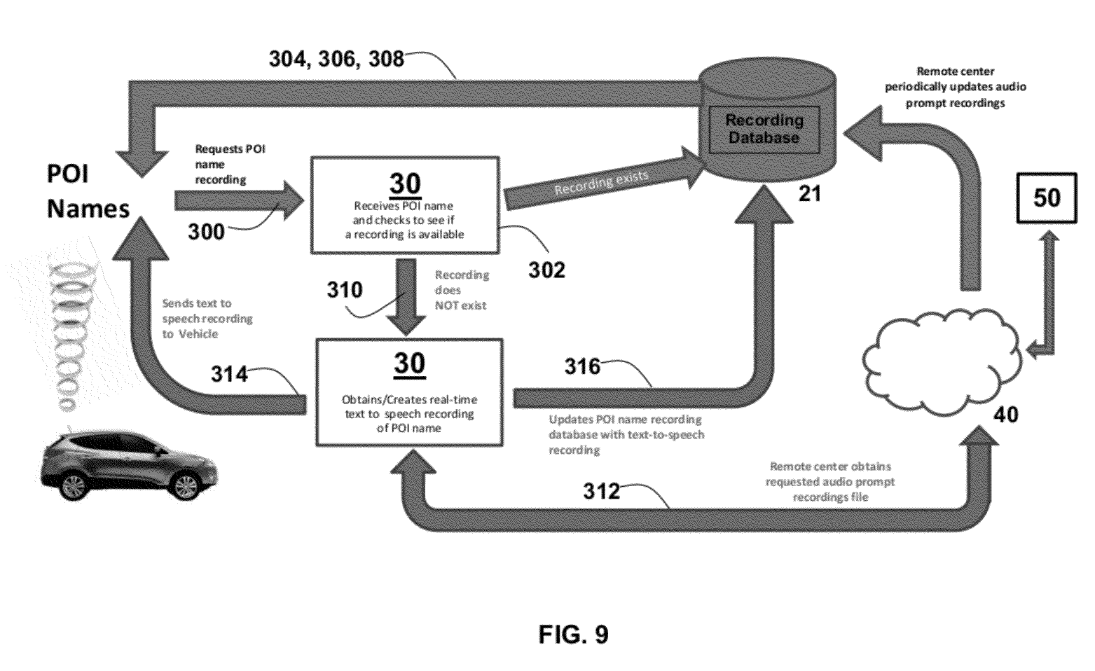

With the example of navigation prompt management explained above, it can be seen that the processes and systems of the invention can be extended to any kind of data, for example, music data management. FIG. 8 shows the process for obtaining data associated with music, for example, pronunciation of song or album or artist names. The process of FIG. 6 is repeated for this example by obtaining the music-related data desired. Likewise, FIG. 9 shows the process for obtaining data associated with points of interest (POI), for example, pronunciation of names of restaurants, attractions, bodies of water, or any other item of interest. The process of FIG. 6 is repeated for this example by obtaining the POI-related data desired.

The inventive prompt management systems and methods lower cost, lower latencies, and are very flexible because they use any text-to-speech technology or human recorded prompts.

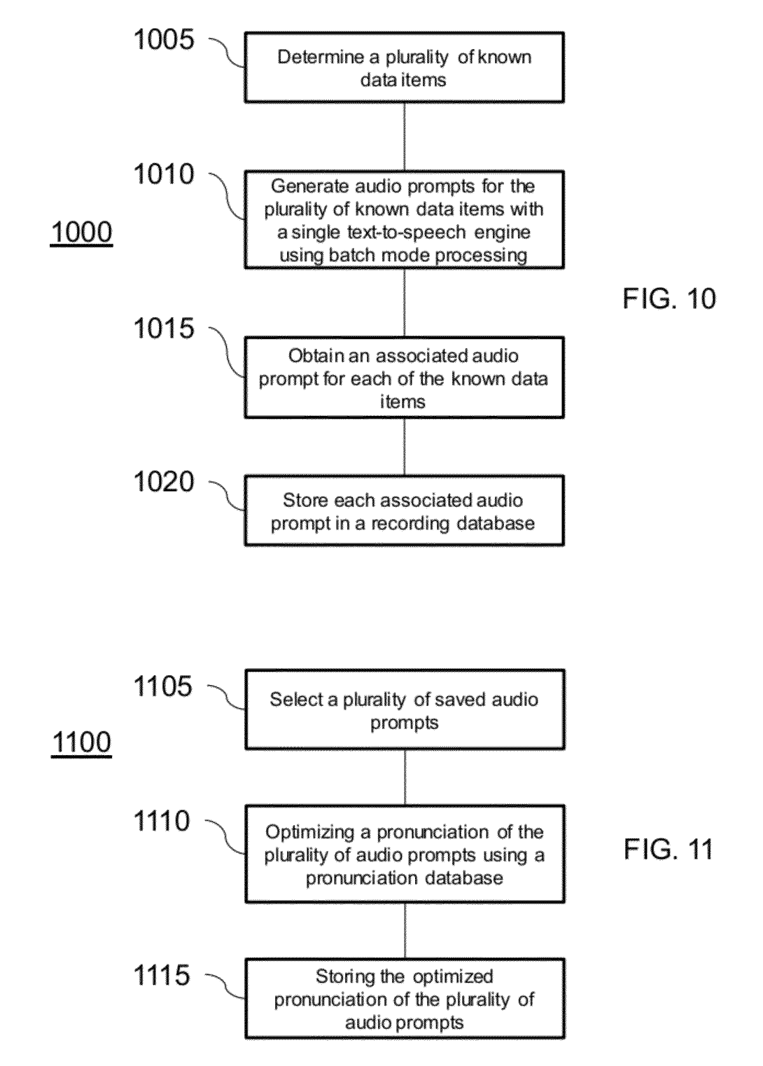

FIG. 10 illustrates a diagram of a method 1000 for obtaining audio prompts using a minimal amount of text-to-speech ports, according to one exemplary embodiment. A plurality of known data items is determined in step 1005. Audio prompts for the plurality of known data items are generated with a single text-to-speech engine using batch mode processing in step 1019. An associated audio prompt is obtained for each of the known data items in step 1015. Each associated audio prompt is stored in a recording database in step 1020.

In one exemplary embodiment, the known data items, e.g. known domains, can be cities, states, and street names. In another exemplary embodiment one or more of the associated audio prompts is selected from the recording database, e.g. by data center 19, in response to a request received from an on-board navigation system of a vehicle. The one or more associated audio prompts is sent from the service-providing remote center, e.g. service provider 30, over a data channel. The single text-to-speech engine can be used in batch mode to create and store millions of audio prompts, any of which can be downloaded to a vehicle for temporary use.

In one exemplary embodiment, a pronunciation of each associated audio prompt is optimized using a pronunciation database. One or more of the optimized associated audio prompts is selected from the recording database, e.g. by data center 19, in response to a request received from an on-board navigation system of a vehicle. The one or more optimized associated audio prompts is/are sent from the service-providing remote center, e.g. service provider 30, over a data channel. In one exemplary embodiment, the optimized audio prompts are optimized to sound like an on-board voice persona of a vehicle.

It is noted that most on-board navigation systems rely on text-to-speech to generate street names that are played back to the vehicle operator, as needed, when voiced-delivered turn-by-turn audio directions are generated during a particular vehicle route. There are three issues with such an approach: 1) the audio quality is low due to vehicle memory limitations that hamper the effectiveness of the text-to-speech engine; 2) special pronunciation rules are needed for each street name for accurate pronunciation; and 3) there is a cost associated with both the text-to-speech technology and the pronunciation rule set. There are millions of street names in the US alone, and it is not practical to pre-record high quality audio for each street name and store such files on-board within the navigation display system of the vehicle. In one exemplary embodiment, a text-to-speech audio prompt can be defined as a wave file, e.g., a text-to-speech street name audio file, that is produced using a high-quality, server-based, text-to-speech capability that has been optimized for street name pronunciation with a persona that, for example, sounds like the on-board voice that is used for the (limited) number of turn-by-turn prompts (e.g., turn left on . . . ; stay on . . . ; for < . . . > miles). The number of turn-by-turn prompts is small enough to allow for storage of all of the audio files within the navigation display system. In addition, human recordings are typically used for turn-by-turn prompts for quality purposes.

FIG. 11 illustrates a diagram of a method 1100 for transferring sound properties into another target, according to one exemplary embodiment. A plurality of saved audio prompts is selected, e.g., by data center 19, in step 1105. In one exemplary embodiment, the plurality of saved audio prompts is resides on a recording database 21 of a service providing remote center, e.g. service provider 30. A pronunciation of the plurality of audio prompts is optimized, in step 1010, using a pronunciation database. The optimized pronunciation of the plurality of audio prompts is stored in step 1015. In one exemplary embodiment, the optimized pronunciation of the plurality of audio prompts is stored on the recording database.

An advantage provided by the present inventive systems and methods is that the use of embedded text-to-speech (TTS) can be eliminated when dynamic prompts are needed. The vehicle can request needed prompts on-the-fly via a web service. Thus, there is no need to perform TTS on-board. When the vehicle needs to play a prompt that is not stored on-board, a request is made to a web service to fetch the prompts and download them to the vehicle for temporary storage. The vehicle can, for example, request a route from a web service, and the web service can figure out which prompts need to be downloaded to the vehicle, e.g., a street service can determine which prompts need to be downloaded to the vehicle. Example downloaded prompts from the street service can be street names in turn-by-turn instructions that are played to a driver during routing. The determination to eliminate the use of embedded TTS can be made by in-vehicle instrumentation, for example, the in-vehicle navigation system.

Although the invention has been described with reference to specific embodiments, these descriptions are not meant to be construed in a limiting sense. Various modifications of the disclosed embodiments, as well as alternative embodiments of the invention, will become apparent to persons skilled in the art upon reference to the description of the invention. It should be appreciated by those skilled in the art that the conception and the specific embodiment disclosed might be readily utilized as a basis for modifying or designing other structures for carrying out the same purposes of the present invention. It should also be realized by those skilled in the art that such equivalent constructions do not depart from the spirit and scope of the invention as set forth in the appended claims.

What is claimed is:

1. A method for providing audio prompts via a service-providing remote center, which comprises:
receiving a list of requested data from an on-board navigation system of a vehicle; and
for each item in the list of requested data:
determining whether an audio prompt is available; and
delivering an associated audio prompt from the service-providing remote center over a data channel.

2. The method of claim 1, which further comprises obtaining the audio prompt for the item when the audio prompt is determined to be unavailable.

3. The method of claim 2, which further comprises carrying out the obtaining step by having the service-providing remote center obtain the item from the Internet cloud.

4. The method of claim 2, which further comprises generating the item with the service-providing remote center.

5. The method of claim 2, which further comprises carrying out the delivering step by sending the associated audio prompt to the vehicle over the data channel from the service-providing remote center.

6. The method of claim 2, which further comprises storing the obtained audio prompt in a recording database of the service-providing remote center.

7. The method of claim 1, which further comprises selecting the associated audio prompt from a recording database of the service-providing remote center when the audio prompt is determined to be available.

8. The method of claim 7, which further comprises carrying out the delivering step by sending the associated audio prompt from the service-providing remote center to the vehicle over the data channel.

9. The method of claim 8, which further comprises selecting a richest available format of the audio prompt and sending the audio prompt in the richest available format.

10. The method of claim 9, wherein the richest available format comprises human voice.

11. The method of claim 9, wherein the richest available format comprises text-to-speech.

12. The method of claim 1, wherein the audio prompt comprises pre-recorded voice data.

13. A method for obtaining audio prompts using a minimal amount of text-to-speech ports, which comprises:
determining a plurality of known data items;
generating audio prompts for the plurality of known data items with a single text-to-speech engine using batch mode processing;
obtaining an associated audio prompt for each of the known data items; and
storing each associated audio prompt in a recording database.

14. The method of claim 13, which further comprises:
selecting one or more of the associated audio prompts from the recording database at a service-providing remote center in response to receiving a request from an on-board navigation system of a vehicle; and
sending the one or more associated audio prompts from the service-providing remote center to the vehicle over a data channel.

15. The method of claim 13, wherein the known data items comprises at least one of cities, states, street names, and points-of-interest.

16. The method of claim 13, which further comprises:
carrying out the generating, obtaining and storing steps at a service-providing remote center; and
optimizing a pronunciation of each associated audio prompt at the service-providing remote center using a pronunciation database.

17. The method of claim 16, which further comprises:
selecting one or more of the optimized associated audio prompts from the recording database in response to a request from an on-board navigation system of a vehicle; and
sending the one or more optimized associated audio prompts from the service-providing remote center to the vehicle over a data channel.

18. The method of claim 16, which further comprises carrying out the optimizing step by having the audio prompts sound like an on-board voice persona of a vehicle.

19. A method for transferring sound properties into another target, which comprises:
selecting a plurality of audio prompts saved in a recording database of a service-providing remote center;
optimizing a pronunciation of the plurality of audio prompts using a pronunciation database of the service-providing remote center; and
saving the optimized pronunciation of the plurality of audio prompts in the recording database.

20. A service-providing remote center, comprising:
a data center operable to process a list of requested data received from an on-board navigation system of a vehicle;
a database containing audio prompts;
a communications data channel; and
a processor operably connected to the data center and the database and being operable to check the database to determine whether an audio prompt is available for each item in the list of requested data and to deliver each associated audio prompt to the vehicle over the communications data channel.
